(19) United States
(12) Patent Application Publication
(10) Pub. No.: US 2011/0246162 A1
(43) Pub. Date: Oct. 6, 2011

(54) TANK WASH SYSTEM

(75) Inventors: Kathleen Brown, Wheaton, IL (US); Rudolf J. Schick, Forest Park, IL (US); Wojciech Kalata, Wood Dale, IL (US)

(73) Assignee: SPRAYING SYSTEMS CO., Wheaton, IL (US)

(21) Appl. No.: 13/075,743

(22) Filed: Mar. 30, 2011

Related U.S. Application Data
(60) Provisional application No. 61/318,968, filed on Mar. 30, 2010.

(51) Int. Cl. G06G 7/48

(52) U.S. Cl. 703/9

(57) ABSTRACT

A tank wash visualization method for planning a tank wash cycle with respect to a tank includes creating a CFD model of the tank system, applying a plurality of parameters to the model, validating the CFD model, including alternate geometries in the model, and based on the model, determining the minimum time needed to successfully clean all parts of the tank.

### CROSS-REFERENCE TO RELATED APPLICATIONS

This patent application claims the benefit of U.S. Provisional Patent Application No. 61/318,968 filed Mar. 30, 2010, which is incorporated herein by reference in its entirety.

### BACKGROUND OF THE INVENTION

In the technology of industrial processing and production, it is common for a container such as a tank to be used to hold a liquid or other material for processing. Processing may include mixing, heating fermentation, etc., and may be carried out in conjunction with other equipment inside or outside of the tank. A critical portion of the processing cycle is to wash the tank periodically so that any material or contamination in the tank is removed. This prevents contamination of future batches which could affect material purity, ingredient ratios and so on.

To ensure thorough cleaning, it is important to ensure that the washing process is appropriately planned, and is then executed in keeping with the plan. A properly executed wash ensures regulatory compliance while minimizing cleaning cycle time and downtime, as well as labor, water, chemical, and wastewater disposal costs.

The planning of a wash process is best done with knowledge of the operation of the washing apparatus, however, it is currently difficult to visualize the washing process. Tanks vary widely in terms of dimensions, shapes, and structures, and the involved rheology, environmental conditions and operating parameters.

### BRIEF SUMMARY OF THE INVENTION

In one embodiment, the invention includes a tank wash visualization method for planning a tank wash cycle with respect to a tank. The method includes creating a CFD model of the tank system, applying a plurality of parameters to the model, validating the CFD model, including alternate geometries in the model, and based on the model, determining the minimum time needed to successfully clean all parts of the tank.

In another embodiment, the invention includes a computer-readable medium having thereon computer executable instructions for performing a tank wash visualization method for planning a tank wash cycle with respect to a tank. The instructions comprises instructions for creating a CFD model of the tank system and instructions for applying a plurality of parameters to the model. The instructions further include instructions for validating the CFD model, instructions for including alternate geometries in the model, and determining the minimum time needed to successfully clean all parts of the tank.

Other objects and advantages of the invention will be appreciated from the following Detailed Description read in conjunction with the drawings of which:

### BRIEF DESCRIPTION OF THE SEVERAL VIEWS OF THE DRAWINGS

FIG. 1 is a cut away perspective depiction of an illustrative containment tank comprising a tank cleaning system usable in accordance with the invention;

FIG. 2 is an enlarged perspective drawing of the tank cleaning portion of the system illustrated in FIG. 1;

FIG. 3 is a schematic diagram illustrating exemplary interconnections within a tank cleaning system according to the invention;

FIG. 4 is a flowchart showing a process of tank wash visualization according to an embodiment of the invention;

FIG. 5 is a data chart showing a parameter space for a washing cycle for various distances according to various embodiments of the invention; and

FIG. 6 is a collection of tank wash plots generated in various embodiments of the invention.

### DETAILED DESCRIPTION OF THE INVENTION

As noted above, the planning of a wash process is best done with knowledge of the operation of the washing apparatus, and yet it is currently difficult for users and customers to visualize the washing process due to wide variations in tank dimensions, shapes, and structures, and the involved rheology, environmental conditions and operating parameters. The invention allows users to easily visualize and verify a planned tank washing process.

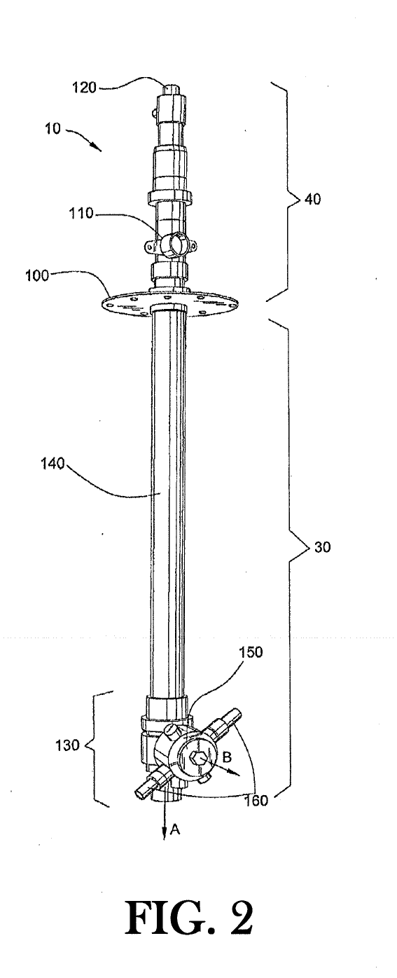

Referring now more particularly to the drawings, there is shown an illustrative tank cleaning apparatus 10 which has particular utility in selectively cleaning the interior surface of a tank 20. The tank cleaning apparatus 10, which will be discussed in greater detail with reference to FIG. 2, comprises a tubular portion 30 extending into the tank 20 and an actuating portion 40 situated outside of the tank 20.

While the inner 30 and outer 40 portions of the cleaning apparatus 10 are in mechanical and fluid communication as will be discussed in greater detail hereinafter, the interior volume of the tank 20 is sealed from external environment via an annular seal, e.g. a deformable or compressible flange at the location 50 in the tank 20 at which the inner tubular portion 30 of the cleaning apparatus 10 enters the tank 20.

During a cleaning process, the tank cleaning apparatus 10 projects a cleaning fluid in one or more streams numbered as 60 against the walls of the tank 20. While projecting the streams 60 against the walls of the tank 20, the tank cleaning system 10 progressively varies the location of impingement of the streams on the tank 20 so as to eventually cleanse substantially the entire interior surface of the tank 20, including the interior portions of flanges, paddles, mixers, and other elements and equipment in fluid communication with the interior of the tank 20.

The manner in which the points of impingement on the interior surface of the tank 20 are controlled will be discussed in greater detail below. It will be appreciated that the impingement of cleaning fluid may be direct with respect to some portions of the interior of the tank 20, while being indirect with respect to other portions. For example, interior surface portions obscured from the stream(s) 60 by equipment or other tank surfaces may be indirectly rather than directly sprayed.

As noted above, the illustrative tank cleaning system 10 comprises a tubular portion 30 extending into the tank 20 and an actuating portion 40 situated outside of the tank 20. A flange 100 separates the inner 30 and outer 40 portions of the cleaning device 10 and serves to seal the device 10 to a tank wall.

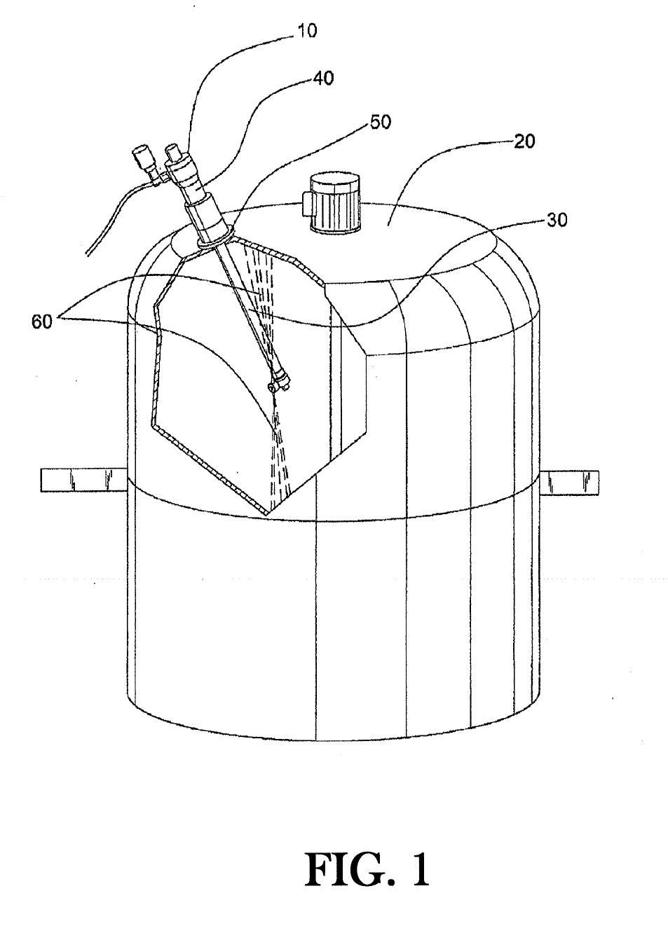

The actuating portion 40 situated outside of the tank 20 further comprises an inlet 110 for receiving pressurized cleaning fluid. The source of cleaning fluid supplied to the inlet 110 is typically a pressurized reservoir, and as such it is sometimes difficult to precisely control the rate of flow of the pressurized fluid through the device 10. The source of fluid can instead be a pump connected to the inlet 110 in accordance with the invention, although such is not required in every embodiment. The received fluid is conveyed to the interior portion 30 of the device 10 and ejected into the attached tank (FIG. 1) for cleaning as will be discussed in greater detail below. The actuating portion 40 situated outside of the tank 20 further comprises an exposed shaft end 120 for mechanically receiving a source of rotational energy (not shown in FIG. 2).

The air motor or electric motor and speed reduction gear assembly 120 is mechanically linked to a shaft which passes through the flange 100 and into the tank interior. A rotational position sensor is mounted to the shaft in such a way that it will detect the rotational position of the shaft. The point of exit of the shaft from the flange is sealed from both the tank interior volume and the inlet 110, so as to convey rotary motion into the tank interior without allowing leakage of the tank contents or the cleaning fluid from the device 110.

The interior portion 30 of the device 10 further comprises a fixed tubular housing 140 and a rotary end portion 130. The rotary end portion 130 further comprises a spray head 150 having thereon one or more spray nozzles 160. The fixed tubular housing contains a shaft (not shown) that is in mechanical registration with the air motor or electric motor 120 via the sensor for transfer or rotary motion therefrom. The outer visible housing 140 has an interior passage containing the shaft that is maintained in fluid communication with inlet 110. It will be appreciated that one or more rotary seals (not shown) may be used to allow for the conveyance of pressurized fluid into the rotating shaft within the housing 140.

As indicated above, the spray head 150 is supplied with pressurized fluid which is ejected from the spray nozzle(s) 160. As the pressurized fluid is ejected from the nozzle(s) 160, the spray head 150 is rotated about a vertical axis A (i.e., the axis of the interior shaft) via the exposed shaft connected to air motor or electric motor 120. In turn, as the spray head 150 rotates about the vertical axis A, the spray head 150 also rotates about a perpendicular axis B due to the geared connection between the spray head 150 and the housing 140.

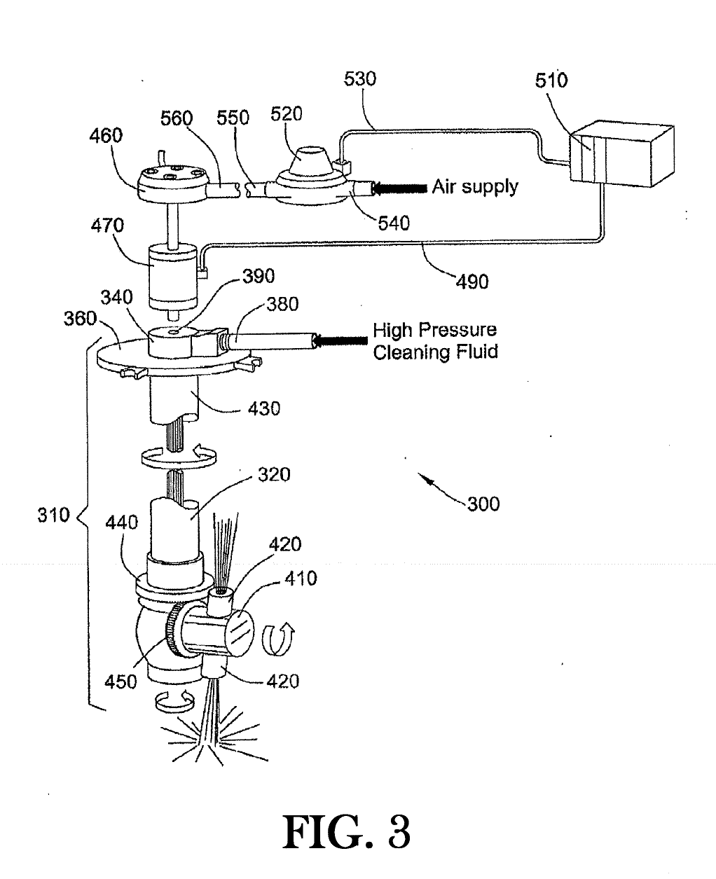

Having discussed the schematic overview of the tank cleaning system that may be visualized within various embodiments of invention, the system will be discussed at a physical level with reference to the cut away perspective view of FIG. 3. The tank cleaning system 300 comprises a tank cleaning device 310 as shown in FIG. 2 (element 10), including a tubular portion 320 (FIG. 2, element 140) extending into the tank and an actuating portion 460 (FIG. 2, element 40), a flange 360 (FIG. 2, element 100), an inlet 380 (FIG. 2, element 110) for receiving pressurized cleaning fluid, an exposed shaft end 390 (FIG. 2, element 120), and a rotary end portion (FIG. 2, element 130) comprising a spray head 410 (FIG. 2, element 150) having thereon one or more spray nozzles 420 (FIG. 2, element 160).

The shaft 430 carries rotary motion from the exposed end shaft 390 to the rotary head including the spray head 410. The geared ring 440 at the end of the tubular housing 320 meshes with the gear 450 affixed to the spray head 410 to turn the head 410 as discussed above. Those of skill in the art will be familiar with the principles of operation of the device 310. A device configured in the described manner is the model AA190 Tank Washer manufactured by SPRAYING SYSTEMS COMPANY of Wheaton, Ill.

To control the operation of the tank cleaning device 310, a motor and gear reduction assembly 460 is connected in rotary registration with the shaft 430 via the exposed end 390. In the illustrated example, the assembly 460 is a geared air driven motor, however it will be appreciated that other types of motors and drive systems may be used.

In the illustrated example, the assembly 460 is affixed to the shaft 430 via a rotational sensor 470. The rotational sensor may be of any suitable type, but is preferably a high resolution rotational sensor (e.g., 17 bits) that tracks both absolute shaft position and number of revolutions executed. The tracking of the absolute shaft position and number of revolutions executed may be performed by the rotary position sensor 470 alone, the controller circuit 510 alone, or a combination of the two elements.

The rotary position sensor sends a data output linked via link 490 to a control circuit 510. The control circuit 510 may be a programmable logic circuit (PLC) that contains control logic (i.e., computer-executable instructions) for the cleaning operation. Alternatively, the control circuit may comprise a computer, workstation, or other computing device for executing the appropriate control logic (e.g., implementing control module 220).

In the illustrated example, the control circuit 510 controls the motor of the assembly 460, and hence the shaft 430, via control of the air pressure supplied to assembly 460. Control of the air pressure supplied to assembly 460 is executed via an electronically controlled pressure regulator (I/P) 520, which receives pressurized air at inlet 540 and provides a controlled output at outlet 550. Outlet 550 is in turn linked to the assembly 460 via a conduit 560.

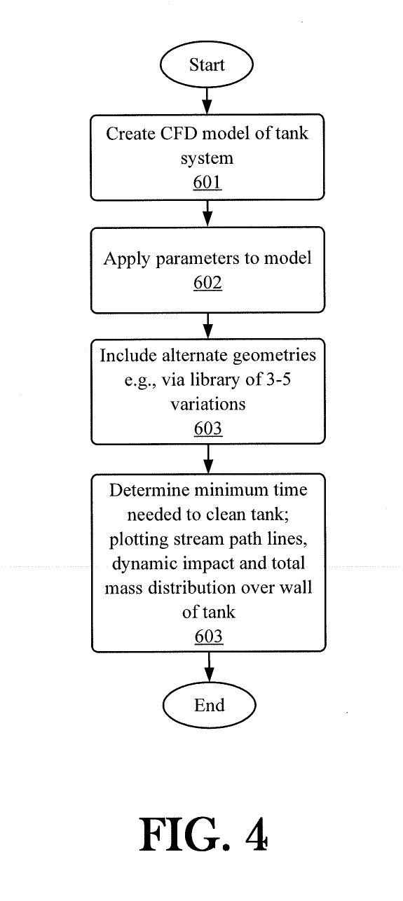

The pressure regulator 520 receives an electrical control signal from the control circuit 510 via electrical link 530. The control signal comprises any suitable signal type and/or protocol, but in a preferred embodiment of the invention the control signal is a 4-20 mA open loop control signal. In turn, the pressure regulator regulates the pressure of air supplied at outlet 550. Thus, the control signal received over link 530 is used to control the speed of the assembly 460 and the shaft 430. Although not shown in FIG. 4, the control circuit 510 also optionally controls one or parameters of the cleaning fluid received at inlet 380 as discussed above.

Referring to the tank wash visualization of the invention, the first stage of the process 600 (FIG. 4) is to create a CFD model of the system in question at stage 601. To this model, a number of parameters are applied in stage 602 including: volume of fluid (VOF), transient, moving meshing, inputs, nozzle rotations, nozzle exit velocity/flow conditions (P, Q, T), output, path lines with respect to time, wall impact (dynamic spray), and volume distribution.

The CFD model was validated using a stainless steel tank of 550 gal. capacity, Ø60″×60″height, with an agitator/obstructions. The spray system included a AA190 nozzle, and sprayed water. TEKSCAN/Pressure Sensitive Paper was used to determine spray pattern and impact strength, and to verify the link between static impact and dynamic impact.

At this point, alternate geometries can be included at stage 603, by way of, for example, a library of 3-5 variations. As another example, the process was verified by using a tanker truck, and in particular, a converted tanker with a viewport to assess CIP system. The results indicate that certain areas of the tank studied were susceptible to inadequate cleaning, especially in the bulkhead. For example, if the CIP device is off-center slightly and the pitch is not correct, then cleaning is not as effective.

At stage 604, the system determines the minimum time needed to successfully clean all parts of the tank by plotting:

1) Stream path lines as a function of time

2) Dynamic impact as a function of time

3) Total mass distribution over the wall of the tanker as a function of time.

The relationship between impact and cleaning efficiency depends on Rheology: viscosity, surface tension, etc. It also depends on environment/operating conditions: length of time exposed, heat cycles, etc. To clean different viscous fluids it is important to know the effect of:

| | | |
|---|---|---|
| α = Angle of attack; | P = Pressure; | Q = Flow rate |
| T = Temperature; | D = Distance; | t = Time |

The invention provides, for given geometry ability to plot spray path lines with respect to time. In one implementation, the invention comprises a body of code prepared for Matlab, and includes cylindrical (conical base optional) style vessels. The nozzle location can be modified, and the wall impact (dynamic spray) and distance are shown, and may be further modified by the application of impact data. Volume distribution is based on nozzle and distance in this implementation, and shadowing/obstructions may also be accommodated via modeling. A library of tank shape, size, and configuration variations can be used to allow visualization for a wider array of tank options.

The use of rheology data is also contemplated in one embodiment of the invention. In particular, the level of removal required can be modeled based on the substance. In a further aspect, the system uses a tired system of removal difficulty (ie: 1—milk, 3—paint, 5—peanut butter, etc.)

In an embodiment of the invention, the system also considers various set cycles (how long material is exposed/dry out time) as well as various tank materials—stainless steel, polyethelene, etc. Rinse cycles (water—sugar, salts, starches; alkali solution—proteins, bacterial films; acidic solution—hard water salts, mineral films; etc) are also considered.

The results of all these considerations allows a more precise determination of tank wash requirements, i.e., Impact with distance and motion based on tank geometry, flow rate required, duration of cleaning cycle, spray coverage/areas of shadowing, level of clean ability (phase 3), and so on.

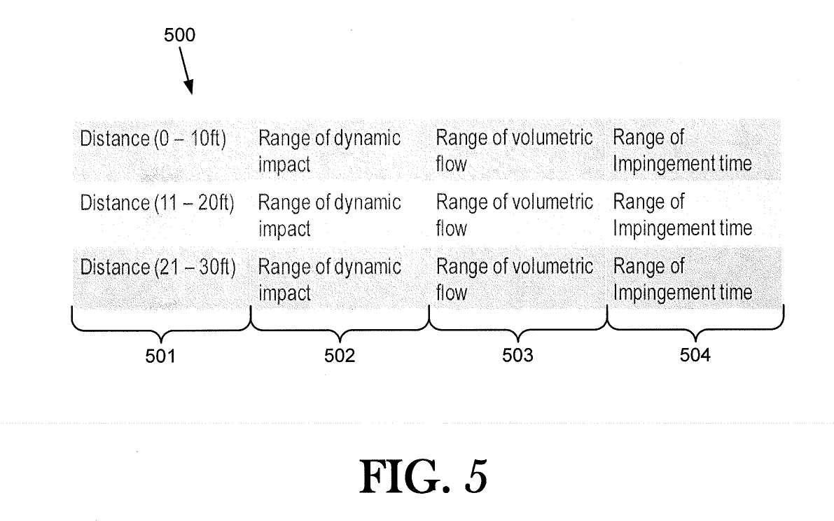

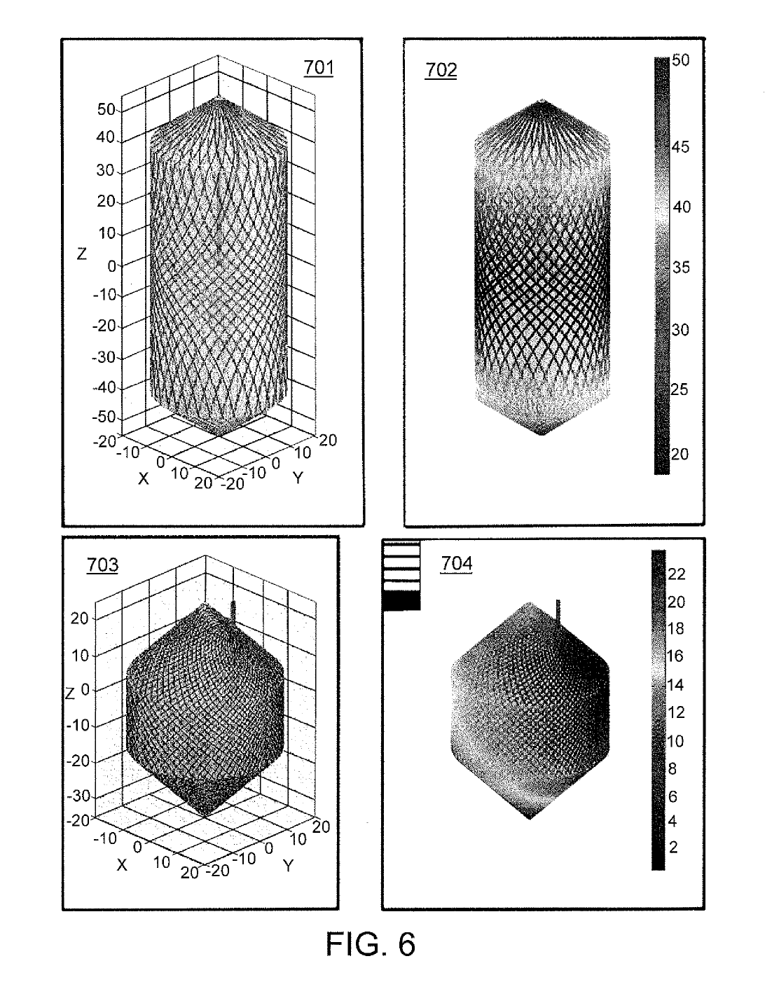

FIG. 5 is a data chart 500 showing a parameter space for a washing cycle for various distances according to various embodiments of the invention for an easily removed substance. As can be seen, the chart maps expected distance 501 to the associated range of dynamic impact 502, range of volumetric flow 503 and range of impingement time 504. FIG. 6 is a collection of tank wash plots 701, 702, 703, and 704 generated in various embodiments of the invention. Each plot 701-704 shows the impingement lines given a planned washing cycle. As can be seen, the impingement density varies within the tank depending upon the nozzle placement and tank geometry.

Although particular embodiments of the invention have been discussed, it will be appreciated that the foregoing methods and implementations are merely examples of the inventive principles, and that these illustrate only preferred techniques. It is contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims as permitted by applicable law. Moreover, any combination of the above-described elements in all possible variations thereof is encompassed by the invention unless otherwise indicated herein or otherwise clearly contradicted by context.

We claim:

1. A tank wash visualization method for planning a tank wash cycle with respect to a tank, the method comprising:
creating a CFD model of the tank system;
applying a plurality of parameters to the model;
validating the CFD model;
including alternate geometries in the model; and
based on the model, determining the minimum time needed to successfully clean all parts of the tank.

2. The tank wash visualization method according to claim 1, wherein the CFD model is adapted to account for effects of angle of attack, pressure, flow rate, temperature, distance, and time.

3. The tank wash visualization method according to claim 1, wherein including alternate geometries in the model includes obtaining alternate geometries from a library of variations.

4. The tank wash visualization method according to claim 1, wherein the applied plurality of parameters include volume of fluid (VOF).

5. The tank wash visualization method according to claim 1, wherein the applied plurality of parameters include nozzle rotations.

6. The tank wash visualization method according to claim 1, wherein the applied plurality of parameters include nozzle exit velocity/flow conditions (P, Q, T).

7. The tank wash visualization method according to claim 1, wherein the applied plurality of parameters include path lines with respect to time.

8. The tank wash visualization method according to claim 1, wherein the applied plurality of parameters include wall impact.

9. The tank wash visualization method according to claim 1, wherein the applied plurality of parameters include volume distribution.

10. The tank wash visualization method according to claim 1, wherein determining the minimum time needed to successfully clean all parts of the tank comprises plotting stream path lines as a function of time, dynamic impact as a function of time and total mass distribution over the wall of the tanker as a function of time.

11. A computer-readable medium having thereon computer executable instructions for performing a tank wash visualization method for planning a tank wash cycle with respect to a tank, the instructions comprising:
instructions for creating a CFD model of the tank system;
instructions for applying a plurality of parameters to the model;
instructions for validating the CFD model;
instructions for including alternate geometries in the model; and
based on the model, determining the minimum time needed to successfully clean all parts of the tank.

12. The computer-readable medium according to claim 11, wherein the CFD model is adapted to account for effects of angle of attack, pressure, flow rate, temperature, distance, and time.

13. The computer-readable medium according to claim 11, wherein the instructions for including alternate geometries in the model include instructions for obtaining alternate geometries from a library of variations.

14. The computer-readable medium according to claim 11, wherein the applied plurality of parameters include volume of fluid (VOF).

15. The computer-readable medium according to claim 11, wherein the applied plurality of parameters include nozzle rotations.

16. The computer-readable medium according to claim 11, wherein the applied plurality of parameters include nozzle exit velocity/flow conditions (P, Q, T).

17. The computer-readable medium according to claim 11, wherein the applied plurality of parameters include path lines with respect to time.

18. The computer-readable medium according to claim 11, wherein the applied plurality of parameters include wall impact.

19. The computer-readable medium according to claim 11, wherein the applied plurality of parameters include volume distribution.

20. The computer-readable medium according to claim 11, wherein the instructions for determining the minimum time needed to successfully clean all parts of the tank comprise instructions for plotting stream path lines as a function of time, dynamic impact as a function of time and total mass distribution over the wall of the tanker as a function of time.
